(19) United States
(12) Patent Application Publication
(10) Pub. No.: US 2024/0092334 A1
(43) Pub. Date: Mar. 21, 2024

(54) METHOD OF SETTING CONTACT POSITION BETWEEN OPERATING CAM AND ROLLER FOR AIR BRAKE, AND OPERATING CAM FOR AIR BRAKE

(71) Applicants: Hyundai Motor Company, Seoul (KR); Kia Corporation, Seoul (KR)

(72) Inventors: Sangheon RYU, Seoul (KR); Sangweol HAN, Suwon-Si (KR); Chulwon LEE, Suwon-Si (KR)

(73) Assignees: Hyundai Motor Company, Seoul (KR); Kia Corporation, Seoul (KR)

(21) Appl. No.: 18/233,721

(22) Filed: Aug. 14, 2023

(30) Foreign Application Priority Data
Sep. 21, 2022 (KR) 10-2022-0119288

(51) Int. Cl. B60T 17/22; F16D 65/00; F16D 65/22

(52) U.S. Cl. CPC B60T 17/221; F16D 65/0043; F16D 65/22; F16D 51/24

(57) ABSTRACT

A method of setting the contact position between the operating cam and the roller for the air brake which includes a leading shoe and a trailing shoe respectively provided with a first roller and a second roller, a first lining and a second lining respectively provided on external surfaces of the leading shoe and the trailing shoe, a drum disposed on a circumference of the back plate, and the operating cam disposed to support the first roller and the second roller therebetween to rotate in a direction of expanding a gap between the leading shoe and the trailing shoe, includes setting the contact position between the operating cam and the second roller so that a direction in which the operating cam presses the second roller during braking is moved in a rotation direction of the drum when the vehicle moves backward thereof.

### CROSS-REFERENCE TO RELATED APPLICATION(S)

The present application claims priority to Korean Patent Application No. 10-2022-0119288, filed on Sep. 21, 2022, the entire contents of which is incorporated herein for all purposes by this reference.

### BACKGROUND OF THE PRESENT DISCLOSURE

### Field of the Present Disclosure

The present disclosure relates to a method of setting a contact position between an operating cam and a roller for an air brake that performs a braking action by air pressure, and the operating cam for the air brake.

### Description of Related Art

In general, an air brake is a pneumatic type drum brake, and includes an operating cam that rotates by air pressure.

When a driver presses a brake pedal to brake a vehicle, the operating cam rotates to widen a gap between both brake shoes, and at the present time, linings attached to the outside of the brake shoes generate a braking force while rubbing against a drum.

The operating cam rotates such that the brake shoes are simultaneously moved, and each of the brake shoes comes into contact with the operating cam through a roller positioned at one end thereof. A conventional operating cam includes an obvious ‘S’ shape and is commonly referred to as an S cam.

When the driver releases the brake pedal, a rotation force applied to the operating cam weakens, and at the present time, both the brake shoes may release braking while returning to initial positions by a return action of a return spring connected therebetween.

Such an air brake has excellent braking power compared to a hydraulic type drum brake, and is thus mainly applied to commercial vehicles such as large trucks.

On the other hand, in the case of the air brake, there is a chronic problem that vibration is induced by a stick-slip phenomenon between the drum and the lining.

The stick-slip phenomenon tends to occur severely on the side of a trailing shoe in which a self-boosting phenomenon occurs during reverse braking.

In the instant case, the conventional operating cam having an obvious ‘S’ shape may press a roller provided on the trailing shoe in a direction away from a rotation center of the trailing shoe.

Therefore, while during braking of a vehicle moving backward, a reaction force behavior is formed between the trailing shoe and the drum in an unstable direction opposite to a rotation direction of the drum, so that vibration may become severe. Because the present vibration is transmitted to the operating cam and a leading shoe through the trailing shoe so that all parts of the air brake are excited, noise in a low frequency band may be induced.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of setting a contact position between an operating cam and a roller for an air brake configured for reducing noise due to a stick-slip phenomenon in a reverse braking situation, and the operating cam for the air brake.

Additional aspects of the present disclosure will be set forth in part in the description which follows, and in part, will be obvious from the description, or may be learned by practice of the present disclosure.

In accordance with an aspect of the present disclosure, a method of setting a contact position between an operating cam and a roller for an air brake, which includes a leading shoe and a trailing shoe respectively provided with a first roller and a second roller at first end portions thereof and disposed to face each other on a back plate fixed to an axle to rotate about second end portions thereof, a first lining and a second lining respectively provided on external surfaces of the leading shoe and the trailing shoe, a drum disposed on a circumference of the back plate to rotate together with a wheel of a vehicle, and the operating cam disposed to support the first roller and the second roller therebetween to rotate in a direction of expanding a gap between the leading shoe and the trailing shoe so that the first and second linings press the drum during braking, includes setting the contact position between the operating cam and the second roller so that a direction in which the operating cam presses the second roller during braking is moved in a rotation direction of the drum when the vehicle moves backward thereof.

The direction in which the operating cam presses the second roller may be a direction in which an extension line extends from the contact point between the second roller and the operating cam to a center portion of the second roller.

The setting of the contact position between the operating cam and the second roller may include bringing the extension line adjacent to the connection line connecting a rotation center of the operating cam and the center portion of the second roller.

The setting of the contact position between the operating cam and the second roller may include bringing the extension line adjacent to a rotation center of the operating cam.

In accordance with an aspect of the present disclosure, a method of setting a contact position between an operating cam and a roller for an air brake, which includes a leading shoe and a trailing shoe respectively provided with a first roller and a second roller at first end portions thereof and disposed to face each other on a back plate fixed to an axle to rotate about second end portions thereof, a first lining and a second lining respectively provided on external surfaces of the leading shoe and the trailing shoe, a drum disposed on a circumference of the back plate to rotate together with a wheel of a vehicle, and the operating cam disposed to support the first roller and the second roller therebetween to rotate in a direction of expanding a gap between the leading shoe and the trailing shoe so that the first and second linings press the drum during braking, includes setting the contact position between the operating cam and the second roller so that a direction in which the operating cam presses the second roller during braking is moved in a direction of a rotation center of the trailing shoe.

In accordance with an aspect of the present disclosure, an operating cam for an air brake, which includes a leading shoe and a trailing shoe respectively provided with a first roller and a second roller at first end portions thereof and disposed to face each other on a back plate fixed to an axle to rotate about second end portions thereof, a first lining and a second lining respectively provided on external surfaces of the leading shoe and the trailing shoe, a drum disposed on a circumference of the back plate to rotate together with a wheel of a vehicle, and the operating cam disposed to support the first roller and the second roller therebetween to rotate in a direction of expanding a gap between the leading shoe and the trailing shoe so that the first and second linings press the drum during braking, presses the second roller so that a direction of a reaction force generated toward the drum at an arbitrary point between the second lining and the drum during braking is deflected in a rotation direction of the drum when the vehicle moves backward based on a normal line passing through the arbitrary point.

The operating cam may form an origin symmetrical structure with respect to a rotation center thereof and as a whole form a tilde shape.

The operating cam may include a pair of pressing portions forming outwardly convexly curved surfaces to press the first roller and the second roller during braking, and a pair of slimming grooves formed inwardly concavely on the opposite side of each of the pressing portions.

A rotation angle of the operating cam may be directly proportional to a movement angle of the roller.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a front view of an air brake to which a method of setting a contact position between an operating cam and a roller for the air brake according to an exemplary embodiment of the present disclosure is applied;

FIG. 2 illustrates a structure of the operating cam for the air brake according to an exemplary embodiment of the present disclosure;

FIG. 3 is a view exemplarily illustrating a process of setting the contact position between the operating cam and the roller according to the method of setting the contact position between the operating cam and the roller for the air brake according to an exemplary embodiment of the present disclosure;

FIG. 4 is a view exemplarily illustrating a process in which a direction of a reaction force acting in a drum direction from a lining on a trailing shoe side is converted during reverse braking according to the method of setting the contact position between the operating cam and the roller for the air brake according to an exemplary embodiment of the present disclosure; and

FIG. 5 is a graph illustrating reaction force characteristics of the operating cam during reverse braking in the air brake to which the method of setting the contact position between the operating cam and the roller for the air brake according to an exemplary embodiment of the present disclosure is applied.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Throughout the specification, like reference numerals refer to like elements. The present specification does not describe all factors of embodiments, and duplicative contents between general contents or embodiments in the field of the present disclosure will be omitted. The terms ‘member,’ ‘module,’ ‘device,’ and ‘block’ used in the present specification may be embodied as software or hardware, and it is also possible for a plurality of ‘members,’ ‘modules,’ ‘devices’ and ‘blocks’ to be embodied as one component, or one ‘member’ ‘module,’ ‘device,’ and ‘block’ to include a plurality of components according to the embodiments.

Throughout the specification, when a part is referred to as being “connected” to another part, it includes not only a direct connection but also an indirect connection, and the indirect connection includes connecting through a wireless network.

When it is described that a part “includes” an element, it means that the element may further include other elements, not excluding the other elements unless specifically stated otherwise.

Throughout the specification, when an element is referred to as being located “on” or “over” another element, this includes not only a case in which an element is in contact with another element but also a case in which another element exists between the two elements.

The terms ‘first,’ etc. are used to distinguish one element from another element, and the elements are not limited by the above-mentioned terms.

The singular forms “a,” “an,” and “the” include plural referents unless the context clearly dictates otherwise.

In each step, an identification numeral is used for convenience of explanation, the identification numeral does not describe the order of the steps, and each step may be performed differently from the order specified unless the context clearly states a particular order.

Hereinafter, the operation principle and embodiments of the present disclosure will be described with reference to the accompanying drawings.

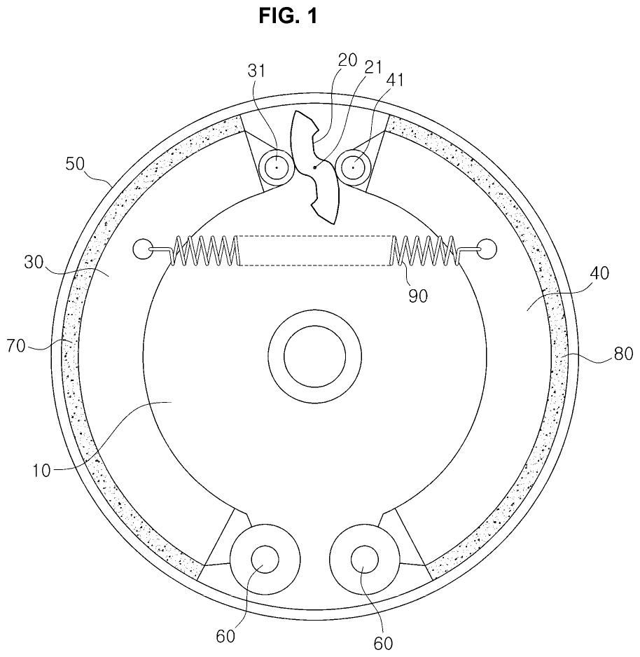

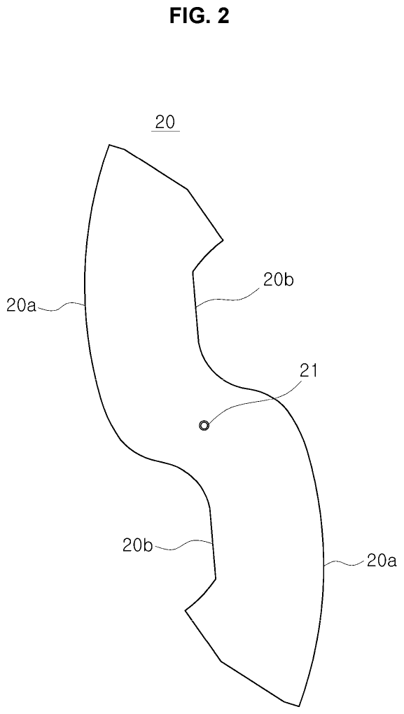

FIG. 1 and FIG. 2 illustrate an overall configuration of an air brake and an operating cam for the air brake according to an exemplary embodiment of the present disclosure.

As illustrated in FIG. 1 and FIG. 2, the air brake according to an exemplary embodiment of the present disclosure includes an operating cam 20 provided on a back plate 10, brake shoes 30 and 40, and a drum 50.

The back plate 10 may be fixed to an axle of a vehicle, and the drum 50 may be disposed at a circumference of the back plate 10 to rotate together with wheels of the vehicle.

The brake shoes 30 and 40 may be configured as a pair. The pair of brake shoes 30 and 40 may be disposed to face each other on both sides of a center portion of the back plate 10 so that one end portions to which rollers 31 and 41 are rotatably coupled rotate about the other end portions, respectively.

The rollers 31 and 41 may be coupled to upper end portions of the brake shoes 30 and 40, respectively, and rotation centers of the brake shoes 30 and 40 may be lower end portions of the brake shoes 30 and 40, respectively.

Anchor pins 60 may be coupled to the back plate 10 at positions corresponding to the lower end portions of the brake shoes 30 and 40, respectively. The lower end portions of the brake shoes 30 and 40 may be coupled to the back plate 10 through the anchor pins 60 to rotate about the anchor pins 60, respectively.

The pair of brake shoes 30 and 40 may rotate outward to widen a gap therebetween during braking.

The pair of brake shoes 30 and 40 may include the leading shoe 30 provided to rotate in a rotation direction of the drum 50 during braking of the vehicle moving forward, and the trailing shoe 40 provided to rotate in a direction opposite to the rotation direction of the drum 50 during braking of the vehicle moving forward thereof.

The rollers 31 and 41 may include the first roller 31 provided on the leading shoe 30 and the second roller 41 provided on the trailing shoe 40.

The operating cam 20 may be rotatably provided on the back plate 10 between the leading shoe 30 and the trailing shoe 40 to support the first roller 31 and the second roller 41 therebetween.

The operating cam 20 may rotate in a direction of widening the gap between the leading shoe 30 and the trailing shoe 40 by air pressure during braking. The rotation direction of the operating cam 20 during braking may be counterclockwise.

The operating cam 20 may be rotated by receiving air pressure through z pressure providing device during braking.

The air pressure providing device may include a chamber that receives compressed air during braking, a slack adjuster which is pushed by the chamber receiving compressed air, and a camshaft that rotates the operating cam 20 counterclockwise by a movement of the slack adjuster.

The operating cam 20 may include a pair of pressing portions 20a provided to simultaneously press the first roller 31 and the second roller 41 during braking.

The operating cam 20 may form an origin symmetrical structure with respect to a rotation center 21 so that the pair of pressing portions 20a are positioned on both sides of the rotation center 21.

Linings 70 and 80 may be provided on external sides of the brake shoes 30 and 40, respectively. The linings 70 and 80 may press and stop the drum 50 to increase a frictional force with the drum 50 rotated by the brake shoes 30 and 40 extending during braking. The linings 70 and 80 may include the first lining 70 provided on the leading shoe 30 and the second lining 80 provided on the trailing shoe 40.

Both end portions of a return spring 90 may be connected to the brake shoes 30 and 40 below the operating cam 20, respectively. When braking is released, the return spring 90 may return the pair of brake shoes 30 and 40, which are expanded to perform braking action, to their original positions.

Therefore, when the driver presses the brake pedal to stop the vehicle in motion, the operating cam 20 rotates counterclockwise to widen the gap between the brake shoes 30 and 40, and at the instant time, the linings 70 and 80 attached to the brake shoes 30 and 40 may be configured to generate a braking force while rubbing against the drum 50.

When the driver releases the brake pedal, a rotation force applied to the operating cam 20 weakens, and at the instant time, the brake shoes 30 and 40 may release the braking while returning to initial positions by a return action of the return spring 90 connected therebetween.

In such an air brake, when the rotating drum 50 is braked, an expansion force of the brake shoes 30 and 40 expanding in the rotation direction of the drum 50 may be increased by adding rotational torque to rotate together with the drum 50 by a frictional force. The present phenomenon is referred to as a self-boosting phenomenon.

On the other hand, because a force to be separated from the drum 50 by the frictional force acts on the brake shoes 30 and 40 expanding in the direction opposite to the rotation direction of the drum 50 during braking, the expansion force of the brake shoes 30 and 40 is reduced.

Accordingly, the self-boosting phenomenon occurs in the leading shoe 30 during braking of the vehicle moving forward, and the self-boosting phenomenon occurs in the trailing shoe 40 during braking of the vehicle moving backward thereof.

On the side of the trailing shoe 40 in which the self-boosting phenomenon occurs during braking of the vehicle moving backward, a stick-slip phenomenon between the drum 50 and the second lining 80 becomes severe, so that excessive vibration may be induced. Because the present vibration is transmitted to the operating cam 20 and the leading shoe 30 through the trailing shoe 40 so that all portions of the air brake are excited, noise in a low frequency band may be induced.

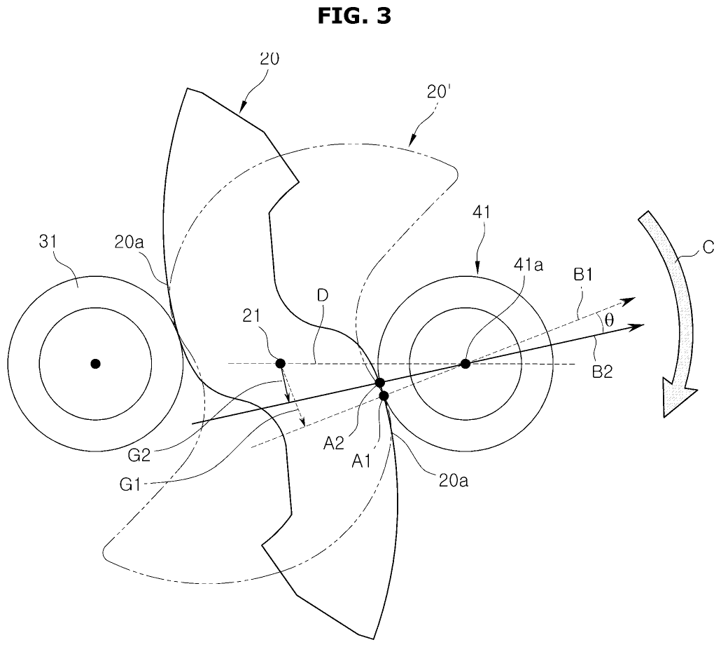

A method of setting a contact position between an operating cairn and a roller for an air brake according to an exemplary embodiment of the present disclosure is to reduce low-frequency noise generated through the trailing shoe 40 during braking of the vehicle moving backward, and FIG. 3 illustrates a process of setting the contact position between the operating cam 20 and the rollers 31 and 41 using the method of setting the contact position between the operating cam and the roller for the air brake according to an exemplary embodiment of the present disclosure.

Because the first roller 31 and the second roller 41 come into contact with the operating cam 20 to form a mutually symmetrical structure on both sides of the operating cam 20, the process of setting the contact position between the operating cam 20 and the second roller 41 will be mainly described below.

In FIG. 3, a contact position A1 indicates a contact position between a conventional operating cam 20′ including an obvious ‘S’ shape and the second roller 41, and a contact position A2 indicates a newly set contact position between the operating cam 20 and the second roller 41 based on the contact position A1.

The contact point A1 may be a contact point between the operating cam 20′ and the second roller 41, and the contact point A2 may be a contact point between the operating cam 20 and the second roller 41. A rotation center of the operating cam 20′ and the rotation center 21 of the operating cam 20 may be concentric.

Furthermore, in FIG. 3, an extension line B1 indicates an extension line extending to connect the contact position A1 and a center portion 41a of the second roller 41, and an extension line B2 indicates an extension line extending to connect the contact position A2 and the center portion 41a of the second roller 41. A symbol C represents a rotation direction of the drum 50 rotating during braking of the vehicle moving backward thereof.

As illustrated in FIG. 3, in the method of setting the contact position between the operating cam and the roller for the air brake according to an exemplary embodiment of the present disclosure, the contact position A2 between the operating cam 20 and the second roller 41 may be set so that a direction in which the operating cam 20 presses the second roller 41 during braking is moved to a direction in which the drum 50 rotates during braking of the vehicle moving backward thereof.

A direction in which the operating cam 20′ presses the second roller 41 may be a direction in which the extension line B1 extends from the contact position A1 to the center portion 41a of the second roller 41, and the direction in which the operating cam 20 presses the second roller 41 may be a direction in which the extension line B2 extends from the contact position A2 to the center portion 41a of the second roller 41.

Therefore, setting the contact position A2 between the operating cam 20 and the second roller 41 so that the direction in which the operating cam 20 presses the second roller 41 is moved in a rotation direction C of the drum 50 rotating during braking of the vehicle moving backward may mean changing the contact position A1 to the contact position A2. Furthermore, this may mean that the extension line B1 is rotated by a predetermined angle θ based on the center portion 41a of the second roller 41 to become the extension line B2 so that the extension line 131 is adjacent to the rotation center 21 of the operating cam 20 or a connection line D connecting the rotation center 21 of the operating cam 20 and the center portion 41a of the second roller 41. The contact position A2 may be set by designing the operating cam 20 so that a shape, inclination, and curve of the pressing portion 20a are different compared to the conventional operating cam 20′. In such the operating cam 20, the curve including the pressing portion 20a is a curve that satisfies that a rotation angle of the operating cam 20 and a displacement of the second roller 41 are directly proportional, that is, the rotation angle of the operating cam 20 and a movement angle of the second roller 41 are directly proportional while maintaining an initial contact point in a state of being inclined by the predetermined angle θ, and may include a more gentle curvature compared to a conventional S-shaped cam.

The operating cam 20, in which the curvature of the pressing portions 20a is formed gently, includes a slimming groove 20b concavely processed on the opposite side of each of the pressing portions 20a to reduce an amount of material, so that the operating cam 20 may be manufactured to form a curved tilde shape while maintaining a generally narrow width along a longitudinal direction thereof.

Compared to the conventional operating cam 20′ including an obvious ‘S’ shape, the operating cam 20 as described above may be formed in a shape close to an ‘8’ shape as the curvature of the pressing portion 20a for pressing the rollers 31 and 41 becomes gentle and a width and shape of an end portion in the longitudinal direction change.

During braking, a reaction force is generated between the drum 50 and the second lining 80, and a direction of the present reaction force may be influenced by a direction of a force applied to the trailing shoe 40 through the operating cam 20 during braking. That is, the direction of the reaction force formed between the drum 50 and the second lining 80 may be changed as a pressing direction of the second roller 41 pressed by the operating cam 20 changes.

When the pressing direction of the operating cam 20, which presses the second roller 41 during braking, is moved to the rotation direction C of the drum 50 according to the backward movement of the vehicle, a point of action of the force applied to the trailing shoe 40 through the second roller 41 is converted to a rotation direction when the drum 50 moves backward, and accordingly, a direction of a reaction force generated at an arbitrary point of the second lining 80 may also be moved along the rotation direction C of the drum 50 during backward movement.

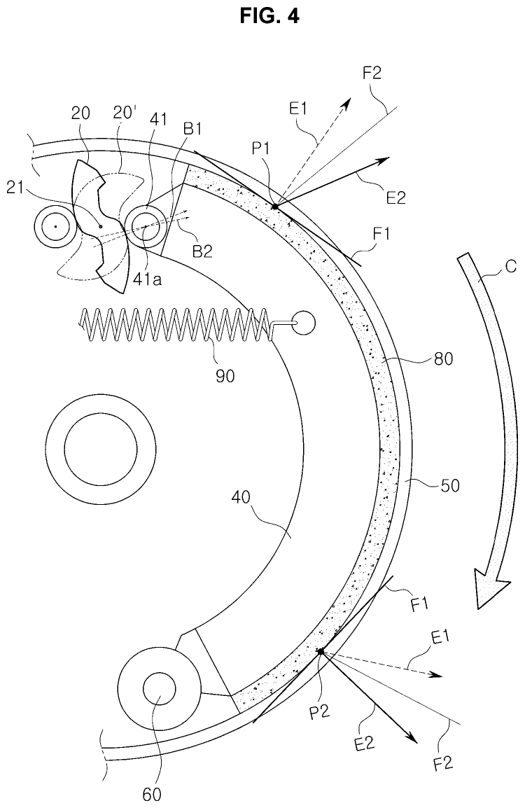

In FIG. 4, an extension line E1 indicates a direction of a reaction force generated at arbitrary points P1 and P2 of the second lining 80 when a pressing tierce of the conventional operating cam 20′ is applied to the second roller 41 along a direction of the extension line B1, and an extension line E2 indicates the direction of the reaction force generated at the points P1 and P2 when a pressing force of the operating cam 20 is applied to the second roller 41 along a direction of the extension line B2. Symbols F1 and F2 indicate a tangent line and a normal line passing through the points P1 and P2, respectively.

As illustrated in FIG. 4, when the pressing direction of the operating cam 20, which presses the second roller 41 during braking, is moved to the rotation direction C of the drum 50 according to the backward movement of the vehicle, a direction of the reaction force generated at an arbitrary point of the second lining 80 may move along the rotation direction C of the drum during backward movement based on the normal line F2. This may mean that a reaction force behavior of the second lining 80 may be stabilized as the direction of the reaction force generated at an arbitrary point of the second lining 80 is converted to a direction adjacent to the rotation center of the trailing shoe 40 (direction of extension line E2) from a direction away from the rotation center of the trailing shoe 40 (direction of extension line E1). Herein, the rotation center of the trailing shoe 40 may be a center portion of the anchor pin 60.

Accordingly, when the reaction force behavior of the second lining 80 during braking is stabilized to be adjacent in the direction of the rotation center of the trailing shoe 40, vibration transmitted between the second lining 80 and the drum 50 may be reduced, and thus vibration transmitted to the operating cam 20 through the trailing shoe 40 or transmitted back to the leading shoe 30 through the operating cam 20 may also be reduced.

Therefore, in the air brake in which the contact position A2 between the operating cam 20 and the second roller 41 is set in the above-described manner, an excitation action between the parts may be generally suppressed during braking of the vehicle moving backward, and through this, noise in a low frequency band caused by the excitation action between parts may be reduced.

Furthermore, as described above, when the contact position A1 between the operating cam 20 and the second roller 41 moves in the direction of the rotation center of the operating cam 20, as the extension line B2 becomes adjacent to the connection line D connecting the rotation center 21 of the operating cam 20 and the center portion 41a of the second roller 41 compared to the extension line B1, a rotational moment arm G2 of the operating cam 20 may be shorter than a moment arm G1 of the conventional operating cam 20′.

Referring back to FIG. 3, the moment arm G1 of the conventional operating cam 20′ may be a vertical distance between the rotation center 21 of the operating cam 20′ and the extension line B1, and the moment arm G2 of the operating cam 20 may be a vertical distance between the rotation center 21 of the operating cam 20 and the extension line B2.

Accordingly, the operating cam 20 including the shortened moment arm G2 may increase the force applied to the second roller 41 even when a same torque is applied. Therefore, because the operating cam 20 more stably brings the trailing shoe 40 into contact with the drum 50 during braking of the vehicle moving backward so that the generation of stick slip is reduced, the operating cam 20 can contribute to more effectively reducing noise generated from the trailing shoe 40 while ensuring a smooth braking action.

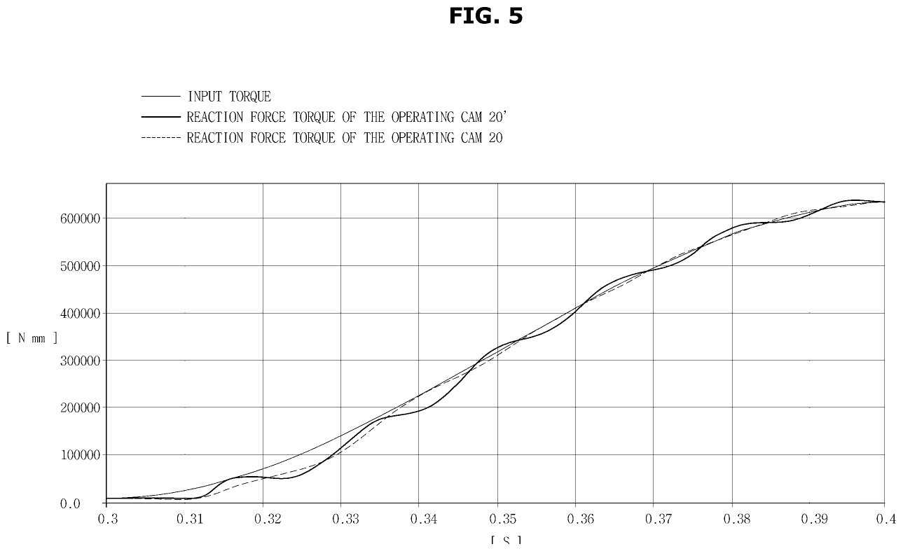

FIG. 5 is a graph illustrating the comparison of reaction force torques generated in the operating cam 20 according to the exemplary embodiment and the conventional operating cam 20′ with respect to input torque during braking of a vehicle moving backward thereof. In FIG. 4, a vertical axis represents time as seconds (s), and a horizontal axis represents torque (Nmm).

As illustrated in FIG. 5, it may be seen that the reaction force torque of the operating cam 20 converges to the input torque as the fluctuation decreases from a latter section in which a proper braking force is exerted, compared to the reaction force torque of the conventional operating cam 20′ during braking of the vehicle moving backward thereof. This may mean that vibrational noise due to excitation between the operating cam 20 and the surrounding components of the air brake during braking of the vehicle moving backward may be reduced.

As is apparent from the above, according to an aspect of the present disclosure, a method of setting a contact position between an operating cam and a roller for an air brake configured for reducing noise due to a stick-slip phenomenon in a reverse braking situation, and the operating cam for the air brake may be provided.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of setting a contact position between an operating cam and a roller for an air brake which includes a leading shoe and a trailing shoe respectively provided with a first roller and a second roller at first end portions thereof and disposed to face each other on a back plate fixed to an axle to rotate about second end portions thereof; a first lining and a second lining respectively provided on external surfaces of the leading shoe and the trailing shoe; a drum disposed on a circumference of the back plate to rotate together with a wheel of a vehicle; and the operating cam disposed to support the first roller and the second roller therebetween to rotate in a direction of expanding a gap between the leading shoe and the trailing shoe so that the first and second linings press the drum during braking, the method comprising:
setting the contact position between the operating cam and the second roller so that a direction in which the operating cam presses the second roller during braking is moved in a rotation direction of the drum when the vehicle moves backward thereof.

2. The method of claim 1, wherein the direction in which the operating cam presses the second roller is a direction in which an extension line extends from a contact point between the second roller and the operating cam to a center portion of the second roller.

3. The method of claim 2, wherein the setting of the contact position between the operating cam and the second roller includes bringing the extension line adjacent to a connection line connecting a rotation center of the operating cam and the center portion of the second roller.

4. The method of claim 2, wherein the setting of the contact position between the operating cam and the second roller includes bringing the extension line adjacent to a rotation center of the operating cam.

5. A method of setting a contact position between an operating cam and a roller for an air brake which includes a leading shoe and a trailing shoe respectively provided with a first roller and a second roller at first end portions thereof and disposed to face each other on a back plate fixed to an axle to rotate about second end portions thereof; a first lining and a second lining respectively provided on external surfaces of the leading shoe and the trailing shoe; a drum disposed on a circumference of the back plate to rotate together with a wheel of a vehicle; and the operating cam disposed to support the first roller and the second roller therebetween to rotate in a direction of expanding a gap between the leading shoe and the trailing shoe so that the first and second linings press the drum during braking, the method comprising:
setting the contact position between the operating cam and the second roller so that a direction in which the operating cam presses the second roller during the braking is moved in a direction of a rotation center of the trailing shoe.

6. The method of claim 5, wherein the direction in which the operating cam presses the second roller is a direction in which an extension line extends from a contact point between the second roller and the operating cam to a center portion of the second roller.

7. The method of claim 6, wherein the setting of the contact position between the operating cam and the second roller includes bringing the extension line adjacent to a connection line connecting a rotation center of the operating cam and a center portion of the second roller.

8. The method of claim 6, wherein the setting of the contact position between the operating cam and the second roller includes bringing the extension line adjacent to a rotation center of the operating cam.

9. An operating cam for an air brake which includes a leading shoe and a trailing shoe respectively provided with a first roller and a second roller at first end portions thereof and disposed to face each other on a back plate fixed to an axle to rotate about second end portions thereof, a first lining and a second lining respectively provided on external surfaces of the leading shoe and the trailing shoe, a drum disposed on a circumference of the back plate to rotate together with a wheel of a vehicle, and the operating cam disposed to support the first roller and the second roller therebetween to rotate in a direction of expanding a gap between the leading shoe and the trailing shoe so that the first and second linings press the drum during braking,
wherein the operating cam presses the second roller so that a direction of a reaction force generated toward the drum at an arbitrary point between the second lining and the drum during the braking is deflected in a rotation direction of the drum when the vehicle moves backward based on a normal line passing through the arbitrary point.

10. The operating cam of claim 9, wherein the operating cam forms an origin symmetrical structure with respect to a rotation center thereof and as a whole forms a tilde shape.

11. The operating cam of claim 10, including:
a pair of pressing portions forming outwardly convexly curved surfaces to press the first roller and the second roller during the braking; and
a pair of slimming grooves formed inwardly concavely on an opposite side of each of the pressing portions.

12. The operating cam of claim 11, wherein a rotation angle of the operating cam is directly proportional to a movement angle of the second roller.

13. The operating cam of claim 12, wherein the rotation angle of the operating cam and a movement angle of the second roller are directly proportional while maintaining an initial contact point in a state of being inclined by a predetermined angle.

14. The operating cam of claim 9, wherein a contact position between the operating cam and the second roller is set so that a direction in which the operating cam presses the second roller during the braking is moved in a direction of a rotation center of the trailing shoe.

15. The operating cam of claim 14, wherein the direction in which the operating cam presses the second roller is a direction in which an extension line extends from a contact point between the second roller and the operating cam to a center portion of the second roller.

16. The operating cam of claim 15, wherein the contact position is set between the operating cam and the second roller by bringing the extension line adjacent to a connection line connecting a rotation center of the operating cam and the center portion of the second roller.

17. The operating cam of claim 15, wherein the contact position is set between the operating cam and the second roller by bringing the extension line adjacent to a rotation center of the operating cam.
